(19) United States
(12) Patent Application Publication
(10) Pub. No.: US 2026/0019166 A1
(43) Pub. Date: Jan. 15, 2026

(54) RADIO TRANSMITTER TEST SYSTEM

(71) Applicant: SUZUKI MOTOR CORPORATION, Hamamatsu-shi (JP)

(72) Inventors: Masayuki ICHINOMIYA, Hamamatsu-shi (JP); Sho KITAGAWA, Hamamatsu-shi (JP); Shinichiro NAKAYAMA, Hamamatsu-shi (JP)

(73) Assignee: SUZUKI MOTOR CORPORATION, Hamamatsu-shi (JP)

(21) Appl. No.: 19/263,247

(22) Filed: Jul. 8, 2025

(30) Foreign Application Priority Data
Jul. 11, 2024 (JP) 2024-111760

(51) Int. Cl. H04B 17/10; H04B 17/00

(52) U.S. Cl. CPC H04B 17/103; H04B 17/0087

(57) ABSTRACT

Provided is a radio transmitter test system that enables accurate measurement of reflected wave power of an antenna. A radio transmitter test system includes: a power amplifier that amplifies power of a high-frequency signal from a signal generator; a simulative antenna for which a voltage standing wave ratio is variable and that is connected to a coaxial cable in place of an antenna; a directional coupler that is connected between the power amplifier and the simulative antenna, couples the high-frequency signal to the simulative antenna, and outputs traveling wave power and reflected wave power between the power amplifier and the simulative antenna; a power meter connected downstream of the directional coupler; and a control device, wherein the control device calculates, for each voltage standing wave ratio of the simulative antenna, a correlation coefficient indicating a correlation between traveling wave power and reflected wave power of the simulative antenna and traveling wave power and reflected wave power measured by the power meter, and calculates reflected wave power of the antenna by correcting, with the correlation coefficient, the traveling wave power and the reflected wave power measured by the power meter in a state where the simulative antenna is replaced by the antenna.

### CROSS-REFERENCE TO RELATED APPLICATION

This application is based upon and claims the benefit of priority from the prior Japanese Patent Application No. 2024-111760, filed on Jul. 11, 2024, the entire contents of which are incorporated herein by reference.

### FIELD

The present invention relates to a radio transmitter test system.

### BACKGROUND

A radio transmitter test is carried out by attaching an antenna to a test cart simulating an onboard transmitter and supplying high-frequency power to the antenna from a radio transmitter via a coaxial cable, for example.

JP 2011-35703A describes a transmitter for emitting radio waves via an antenna. The transmitter includes a power amplifier that amplifies power of a high-frequency signal input to the power amplifier, a directional coupler that couples the high-frequency signal whose power has been amplified to the antenna, a voltage variable attenuator connected to the upstream side of the power amplifier, and a control device. The directional coupler detects traveling wave power and reflected wave power between the power amplifier and the antenna and outputs the traveling wave power and the reflected wave power to the control device.

The control device determines a stable operating state of the transmitter based on the value of the traveling wave power, calculates a voltage standing wave ratio from the values of the traveling wave power and the reflected wave power, compares the voltage standing wave ratio with a threshold, and controls power amplification of the high-frequency signal in the power amplifier.

The transmitter described in JP 2011-35703A reduces output before the output reaches a prescribed value to prevent the reflected wave power that is input to the power amplifier from exceeding an allowable value even for a moment, and thus avoids unnecessary reduction and suspension of output of the transmission power amplifier and enables more stable transmitting operations.

### SUMMARY OF THE DISCLOSURE

The radio transmitter test described above is preferably carried out by accurately measuring reflected wave power of the antenna connected to the coaxial cable and supplying effective power (net power) obtained by subtracting the reflected wave power from traveling wave power to the antenna.

However, when power is supplied to the antenna that is to be tested by transmitting high-frequency power from the radio transmitter via an internal conductor of the coaxial cable, if reflection occurs at a power feeding point on the antenna, the reflected wave power of the antenna is conducted via an external conductor of the coaxial cable and transmitted toward the radio transmitter. The external conductor of the coaxial cable serves as a ground or earth, and accordingly, it is difficult to accurately measure the reflected wave power at a position far from the power feeding point on the antenna.

The transmitter described in JP 2011-35703A merely controls the power amplifier based on the voltage standing wave ratio calculated from the values of the traveling wave power and the reflected wave power, which are output from the directional coupler, and no consideration is given to transmission loss of the reflected wave power of the antenna connected to the coaxial cable. Therefore, even if the transmitter described in JP 2011-35703A is applied to the radio transmitter test described above, it is not possible to accurately measure the reflected wave power of the antenna to be tested.

In view of the above problems, it is an object of the present invention to provide a radio transmitter test system that enables accurate measurement of reflected wave power of an antenna.

In order to solve the above problems, a representative configuration of a radio transmitter test system according to the present invention includes: an antenna connected to a coaxial cable; a signal generator configured to generate a high-frequency signal; a power amplifier configured to amplify power of the high-frequency signal; a simulative antenna for which a voltage standing wave ratio indicating a transmission efficiency of high-frequency power is variable and that is connected to the coaxial cable in place of the antenna; a directional coupler that is connected between the power amplifier and the simulative antenna, is configured to couple high-frequency signal whose power has been amplified to the simulative antenna, and to output traveling wave power and reflected wave power between the power amplifier and the simulative antenna; a power meter that is connected downstream of the directional coupler and is configured to measure the traveling wave power and the reflected wave power output from the directional coupler; and a control device configured to calculate reflected wave power of the antenna, wherein the control device includes: a correlation coefficient calculating unit configured to calculate, for each voltage standing wave ratio of the simulative antenna, a correlation coefficient indicating a correlation between traveling wave power and reflected wave power of the simulative antenna and the traveling wave power and the reflected wave power measured by the power meter; and a power value calculating unit configured to calculate reflected wave power of the antenna by correcting, with the correlation coefficient, the traveling wave power and the reflected wave power measured by the power meter in a state where the simulative antenna is replaced by the antenna.

According to the present invention, it is possible to provide a radio transmitter test system that enables accurate measurement of reflected wave power of an antenna.

### BRIEF DESCRIPTION OF THE DRAWINGS

FIG. 1 is a functional block diagram of a radio transmitter test system according to an embodiment of the present invention.

FIGS. 2A and 2B are schematic diagrams showing an antenna and a coaxial cable included in the radio transmitter test system shown in FIG. 1.

FIG. 3 is a diagram showing a main part of the radio transmitter test system shown in FIG. 1.

FIG. 4 is a flowchart showing a procedure of a radio transmitter test carried out using the radio transmitter test system shown in FIG. 1.

FIG. 5 is a diagram showing a state where the antenna is connected to the coaxial cable in place of a simulative antenna in the radio transmitter test system shown in FIG. 3.

FIG. 6 is a diagram showing a radio transmitter test system according to a variation.

FIG. 7 is a diagram showing a state where an antenna is connected to a coaxial cable in place of a simulative antenna in the radio transmitter test system shown in FIG. 6.

FIG. 8 is a diagram showing a variation of the radio transmitter test system shown in FIG. 5.

### DETAILED DESCRIPTION

A preferable embodiment of the present invention will be described in detail below with reference to the attached drawings. Dimensions, materials, other specific values, and the like described in this embodiment are merely examples for facilitating understanding of the invention, and are not intended to limit the present invention unless stated otherwise. Note that in the present specification and drawings, elements having substantially the same functions and configurations are assigned the same reference numerals to omit redundant descriptions, and elements that are not directly related to the present invention are omitted in the drawings.

A radio transmitter test system according to an embodiment of the present invention includes: an antenna connected to a coaxial cable; a signal generator configured to generate a high-frequency signal; a power amplifier configured to amplify power of the high-frequency signal; a simulative antenna for which a voltage standing wave ratio indicating a transmission efficiency of high-frequency power is variable and that is connected to the coaxial cable in place of the antenna; a directional coupler that is connected between the power amplifier and the simulative antenna, is configured to couple a high-frequency signal whose power has been amplified to the simulative antenna, and to output traveling wave power and reflected wave power between the power amplifier and the simulative antenna; a power meter that is connected downstream of the directional coupler and is configured to measure the traveling wave power and the reflected wave power output from the directional coupler; and a control device configured to calculate reflected wave power of the antenna, wherein the control device includes: a correlation coefficient calculating unit configured to calculate, for each voltage standing wave ratio of the simulative antenna, a correlation coefficient indicating a correlation between traveling wave power and reflected wave power of the simulative antenna and the traveling wave power and the reflected wave power measured by the power meter; and a power value calculating unit configured to calculate reflected wave power of the antenna by correcting, with the correlation coefficient, the traveling wave power and the reflected wave power measured by the power meter in a state where the simulative antenna is replaced by the antenna.

In the above configuration, the simulative antenna (e.g., a variable impedance terminal device) for which the voltage standing wave ratio is variable is connected to the coaxial cable in advance of the test target antenna, the directional coupler is connected between the power amplifier and the simulative antenna, and the power meter is connected downstream of the directional coupler.

The control device measures traveling wave power and reflected wave power at the simulative antenna and the power meter for each voltage standing wave ratio of the simulative antenna, and calculates the correlation coefficient indicating the strength of correlation between the power values by creating a correction curve based on the power values, for example. Then, the control device can calculate reflected wave power of the antenna by correcting, with the correction coefficient, traveling wave power and reflected wave power that are measured by the power meter in the state where the test target antenna is connected to the coaxial cable in place of the simulative antenna.

It is preferable that the power value calculating unit is configured to calculate net power, which is effective power, by subtracting the calculated reflected wave power from the traveling wave power of the antenna, and the control device further includes a control unit configured to control output of the signal generator to supply the net power to the antenna.

With this configuration, it is possible to not only measure the reflected wave power of the antenna but also perform a radio transmitter test by supplying the net power to the antenna.

It is preferable that the radio transmitter test system further includes: an attenuator that is connected between the directional coupler and the simulative antenna via a selector, is configured to attenuate reflected wave power from the simulative antenna, and to output the attenuated reflected wave power to the power amplifier; and a filter configured to remove high-frequency components of the reflected wave power or to perform impedance matching of a transmission path of high-frequency power, and the control unit is configured to connect the attenuator or the filter between the directional coupler and the simulative antenna by switching the selector.

It is possible to connect the attenuator or the filter between the directional coupler and the simulative antenna as described above, and accordingly, it is possible to prevent the power amplifier from being broken by the reflected wave power transmitted from the simulative antenna.

It is preferable that the radio transmitter test system further includes: another directional coupler that is connected immediately below the antenna, is configured to couple a signal in a low-frequency band to the antenna, and to output traveling wave power and reflected wave power; and another power meter that is connected downstream of the other directional coupler, and is configured to measure the traveling wave power and the reflected wave power output from the other directional coupler.

When a signal in the low-frequency band (e.g., 3 to 30 MHz) is transmitted to the coaxial cable, the other directional coupler is connected immediately below the antenna and the other power meter is connected downstream of the other directional coupler as described above, and thus the reflected wave power of the antenna can be measured accurately.

### Example

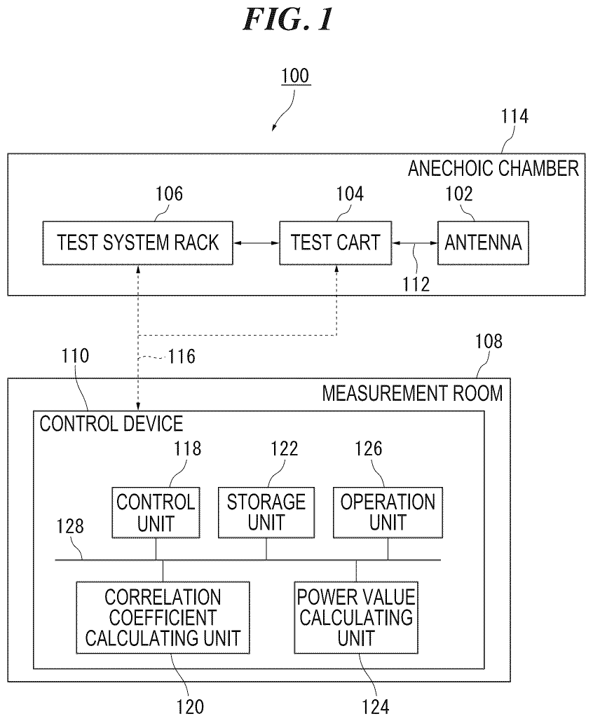

FIG. 1 is a functional block diagram of a radio transmitter test system 100 according to an example of the present invention. The radio transmitter test system 100 is a system for carrying out a radio transmitter test by supplying power to an antenna 102 that is the test target, and includes a test cart 104 simulating an onboard transmitter, a test system rack 106, and a control device 110 installed in a measurement room 108.

The antenna 102, the test cart 104, and the test system rack 106 are electrically connected to each other by a coaxial cable 112 that is used as a transmission path, and are installed in an anechoic chamber 114 to examine the influence of electromagnetic waves radiated from the antenna 102. The antenna 102 is attached to the test cart 104.

The control device 110 is connected to the test cart 104 and the test system rack 106 by a control signal cable 116 shown by dotted lines in the diagram. Although details are described later, the control device 110 includes a control unit 118, a correlation coefficient calculating unit 120, a storage unit 122, a power value calculating unit 124, and an operation unit 126, and these units are connected to each other by an internal bus 128.

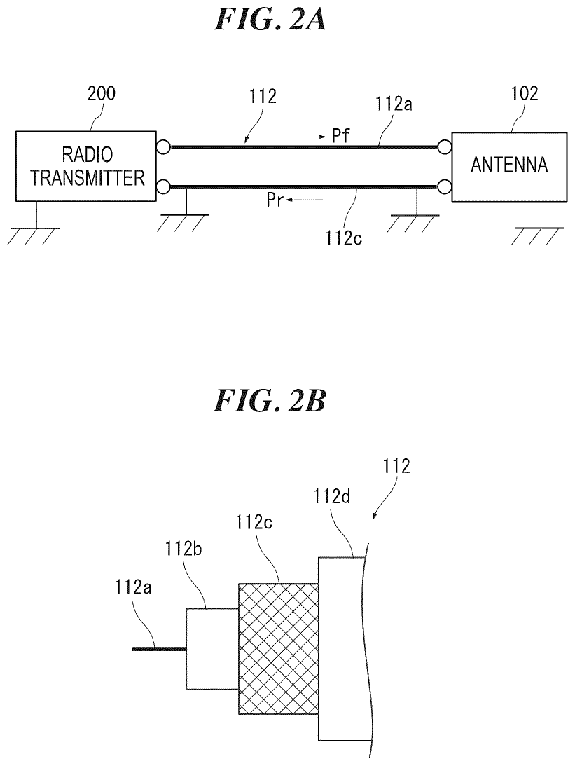

FIGS. 2A and 2B are schematic diagrams showing the antenna 102 and the coaxial cable 112 included in the radio transmitter test system 100 shown in FIG. 1. FIG. 2A schematically shows a radio transmitter test in which power is supplied from an existing radio transmitter 200 to the antenna 102, which is a load, via the coaxial cable 112. FIG. 2B shows an internal structure of the coaxial cable 112.

The coaxial cable 112 has a circular cross section and is constituted by four layers shown in FIG. 2B, i.e., an internal conductor 112a, an insulator 112b, an external conductor 112c, and an external covering 112d that are coaxially layered on each other. The internal conductor 112a is a copper wire located at the center of the circular cross section and transmits electrical signals. The insulator 112b is an insulating layer surrounding the internal conductor 112a.

The external conductor 112c of the coaxial cable 112 is a braided wire or a mesh wire surrounding the outer side of the insulator 112b, serves as a ground or earth during transmission, and has a shielding effect of preventing signal leakage to the outside and intrusion of radio waves from the outside. The external covering 112d is a jacket that is also known as “vinyl” or “protective covering” and serves as a protective cover forming the outermost layer of the coaxial cable 112.

As shown in FIG. 2A, when power is supplied to the antenna 102 that is to be tested by transmitting high-frequency power from the radio transmitter 200 via the internal conductor 112a of the coaxial cable 112, traveling wave power Pf is transmitted toward the antenna 102. If reflection occurs at a power feeding point on the antenna 102, reflected wave power Pr of the antenna 102 is conducted via the external conductor 112c of the coaxial cable 112 and transmitted toward the radio transmitter 200. However, the external conductor 112c of the coaxial cable 112 serves as a ground or earth, and accordingly, it is difficult to accurately measure the reflected wave power at a position far from the power feeding point on the antenna 120.

Therefore, the radio transmitter test system 100 adopts a configuration that makes it possible to accurately measure reflected wave power of the antenna 102 connected to the coaxial cable 112 and carry out a radio transmitter test by supplying the net power that is obtained by subtracting the reflected wave power from the traveling wave power to the antenna 102.

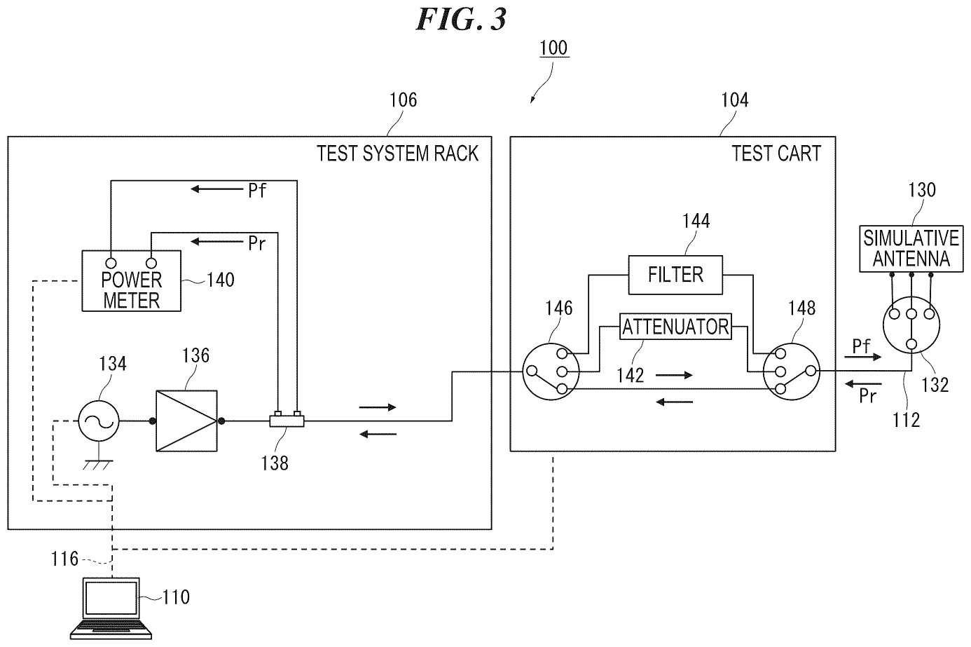

FIG. 3 is a diagram showing a main part of the radio transmitter test system 100 shown in FIG. 1. The radio transmitter test system 100 includes a simulative antenna 130. The simulative antenna 130 is a variable impedance terminal device for which the voltage standing wave ratio (VSWR) that indicates a transmission efficiency of high-frequency power is variable. The simulative antenna 130 is connected to the coaxial cable 112 to be attached to the test cart 104, in advance of the test target antenna 102.

A plurality of (e.g., three) voltage standing wave ratios are set for the simulative antenna 130, and the plurality of voltage standing wave ratios can be selected by switching a selector 132. Note that the voltage standing wave ratio VSWR can be calculated using the following formula (1) based on traveling wave power Pf and reflected wave power Pr.

A signal generator 134, a power amplifier 136, a directional coupler 138, and a power meter 140 are installed on the test system rack 106. The signal generator 134 generates a high-frequency signal, and output of the signal generator 134 is controlled by the control unit 118 of the control device 110 (see FIG. 1). The power amplifier 136 amplifies the power of the high-frequency signal output from the signal generator 134.

The directional coupler 138 is connected between the power amplifier 136 and the simulative antenna 130. The directional coupler 138 couples the high-frequency signal whose power has been amplified to the simulative antenna 130, obtains traveling wave power Pf and reflected wave power Pr between the power amplifier 136 and the simulative antenna 130, and outputs the traveling wave power Pf and the reflected wave power Pr. The power meter 140 is connected downstream of the directional coupler 138 and measures the traveling wave power Pf and the reflected wave power Pr output from the directional coupler 138.

An attenuator 142, a filter 144, and selectors 146 and 148 are installed on the test cart 104. As shown in the diagram, the attenuator 142 and the filter 144 are connected between the directional coupler 138 and the simulative antenna 130 via the selectors 146 and 148. The attenuator 142 attenuates reflected wave power Pr transmitted from the simulative antenna 130 and outputs the attenuated power to the power amplifier 136. The filter 144 removes high-frequency components of the reflected wave power Pr or performs impedance matching on the transmission path of high-frequency power.

The control unit 118 shown in FIG. 1 connects the attenuator 142 or the filter 144 between the directional coupler 138 and the simulative antenna 130 by switching the selectors 146 and 148. With this configuration, it is possible to prevent the power amplifier 136 from being broken by the reflected wave power Pr transmitted from the simulative antenna 130.

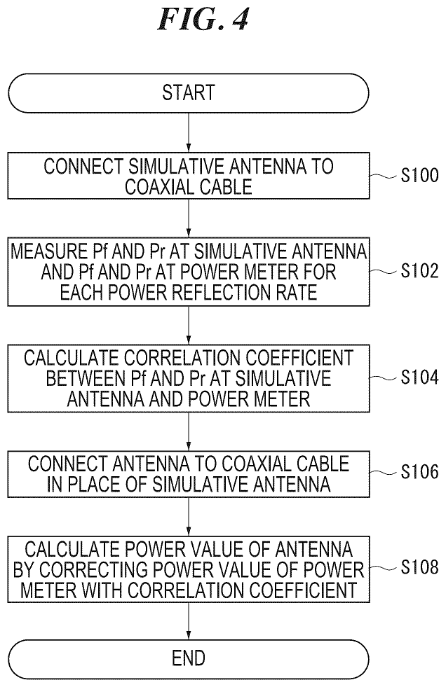

FIG. 4 is a flowchart showing a procedure of a radio transmitter test carried out using the radio transmitter test system 100 shown in FIG. 1. First, as shown in FIG. 3, the simulative antenna 130 is connected to the coaxial cable 112 in advance of the test target antenna 102 (step S100).

Next, the correlation coefficient calculating unit 120 of the control device 110 measures traveling wave power Pf and reflected wave power Pr at the simulative antenna 130 and traveling wave power Pf and reflected wave power Pr at the power meter 140 for each voltage standing wave ratio (each power reflection ratio) of the simulative antenna 130 (step S102). The voltage standing wave ratio of the simulative antenna 130 can be selected appropriately by switching the selector 132 with use of the control unit 118, for example. Furthermore, it is possible to obtain a plurality of power values by controlling output of the signal generator 134 with use of the control unit 118 to change the frequency of the high-frequency signal and performing the processing in step S102 for each frequency. The thus obtained plurality of power values are stored in the storage unit 122 by the correlation coefficient calculating unit 120.

Subsequently, the correlation coefficient calculating unit 120 reads each power value obtained in step S102, i.e., the traveling wave power Pf and the reflected wave power Pr at the simulative antenna 130 and the power meter 140 for each voltage standing wave ratio from the storage unit 122 and calculates a correlation coefficient indicating the strength of correlation between the power values by creating a correction curve based on the power values, for example (step S104). The correlation coefficient calculating unit 120 stores the calculated correlation coefficient in the storage unit 122.

As described above, in the radio transmitter test system 100, the extent to which reflected wave power of the simulative antenna 130, for which the voltage standing wave ratios are set in advance, attenuates before the reflected wave reaches the power meter 140 connected downstream of the directional coupler 138 can be grasped in advance with use of an index, i.e., the correlation coefficient.

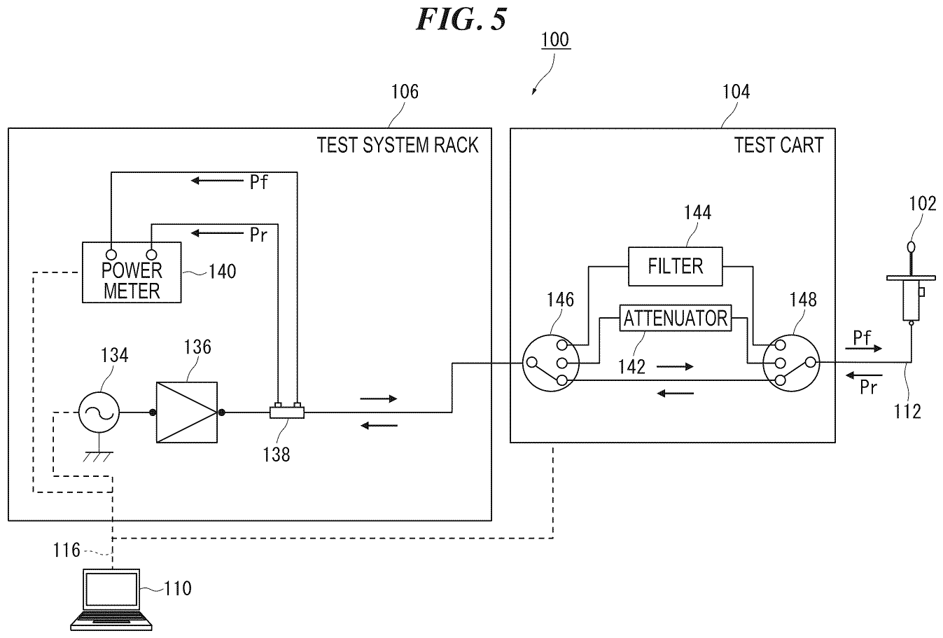

After step S104, the antenna 102 is connected to the coaxial cable 112 as shown in FIG. 5 in place of the simulative antenna 130 (step S106). Thus, the test target antenna 102 is attached to the test cart 104.

FIG. 5 is a diagram showing the state where the antenna 102 is connected to the coaxial cable 112 in place of the simulative antenna 130 in the radio transmitter test system 100 shown in FIG. 3. In the radio transmitter test system 100 shown in FIG. 5, power is supplied to the test target antenna 102, and traveling wave power Pf and reflected wave power Pr are measured by the power meter 140.

Subsequently, the power value calculating unit 124 reads the correlation coefficient from the storage unit 122 and calculates reflected wave power of the antenna 102 by correcting the traveling wave power Pf and the reflected wave power Pr measured by the power meter 140 (step S108). Note that each processing performed in the steps S102, S104, and S108 described above can be executed appropriately based on a signal input from the operation unit 126 of the control device 110.

As described above, in the radio transmitter test system 100, a correlation coefficient indicating a correlation between a power value of the power meter 140 downstream of the directional coupler 138 and a power value of the simulative antenna 130 is determined through preliminary measurement performed with use of the simulative antenna 130 for which the voltage standing wave ratio is variable, in advance of the test of the antenna 102. Then, a power value of the power meter 140 measured by supplying power to the antenna 102 is corrected with the correlation coefficient, and thus the reflected wave power of the antenna 102 can be measured accurately.

Furthermore, after step S108, the power value calculating unit 124 calculates the net power, which is the effective power, by subtracting the reflected wave power Pr of the antenna 102 calculated in step S108 from traveling wave power Pf of the antenna 102. Also, the control unit 118 controls output of the signal generator 134 to supply the net power to the antenna 102.

With this configuration, the radio transmitter test system 100 makes it possible to not only measure reflected wave power of the antenna 102 accurately but also perform a radio transmitter test by supplying the net power to the antenna 102. Therefore, the radio transmitter test system 100 can be used for a so-called immunity test for examining, for example, whether or not a malfunction occurs in an in-vehicle device due to electromagnetic waves radiated from the antenna 102.

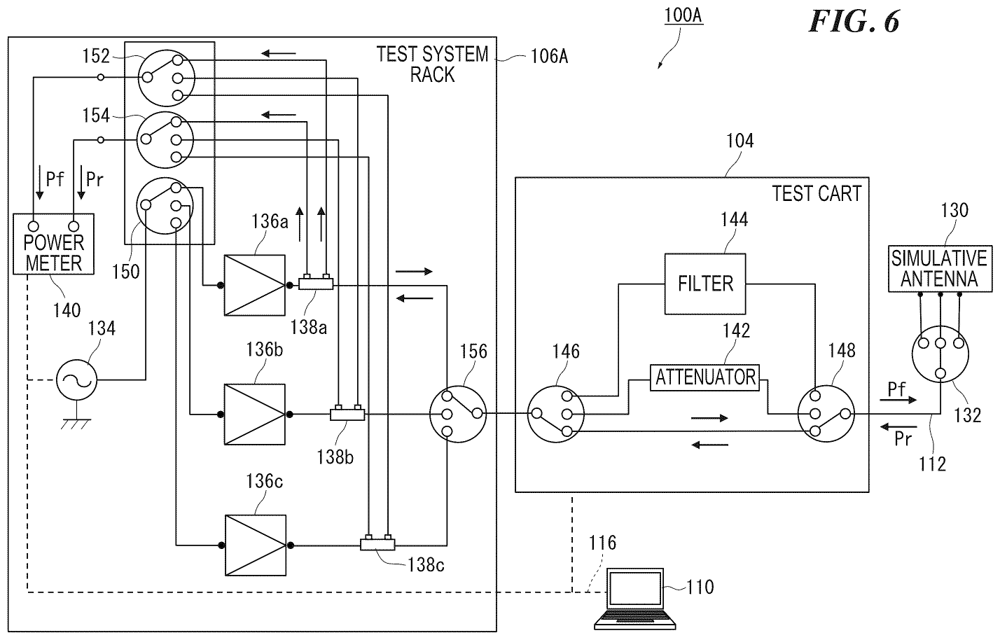

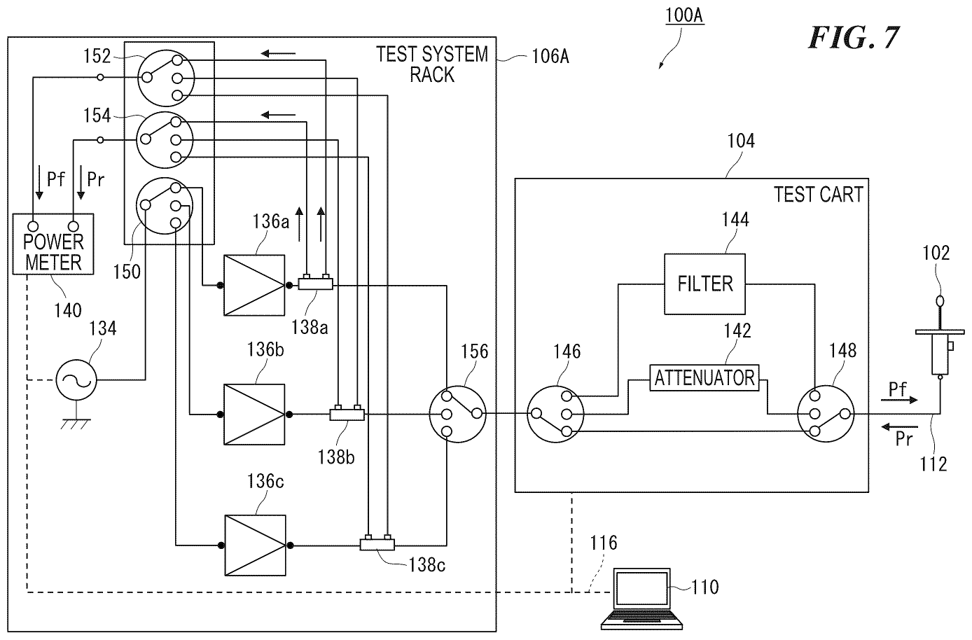

FIG. 6 is a diagram showing a radio transmitter test system 100A according to a variation. FIG. 7 is a diagram showing a state where the antenna 102 is connected to the coaxial cable 112 in place of the simulative antenna 130 in the radio transmitter test system 100A shown in FIG. 6.

The radio transmitter test system 100A includes a test system rack 106A. The test system rack 106A differs from the test system rack 106 described above in that three power amplifiers 136a, 136b, and 136c respectively corresponding to three different frequency bands, directional couplers 138a, 138b, 138c, and selectors 150, 152, 154, and 156 are installed on the test system rack 106A.

The signal generator 134 is connected to the power amplifiers 136a, 136b, and 136c via the selector 150. The directional couplers 138a, 138b, and 138c are connected between the selector 156 and the power amplifiers 136a, 136b, and 136c, respectively.

The power meter 140 is connected downstream of the directional couplers 138a, 138b, and 138c via the selectors 152 and 154. Accordingly, the traveling wave power and reflected wave power output from the directional couplers 138a, 138b, and 138c are measured by the power meter 140 via the selectors 152 and 154, respectively. Here, a state is shown in which the power of a high-frequency signal output from the signal generator 134 is amplified by the power amplifier 136a, and traveling wave power Pf and reflected wave power Pr output from the directional coupler 138a are measured by the power meter 140.

With this configuration, it is possible to amplify the power of a high-frequency signal with use of the three power amplifiers 136a, 136b, and 136c by appropriately switching the selectors 150, 152, 154, and 156 with use of the control unit 118 (see FIG. 1).

In the radio transmitter test system 100A, a correlation coefficient indicating a correlation between a power value of the power meter 140 downstream of the directional couplers 138a, 138b, and 138c and a power value of the simulative antenna 130 is determined through preliminary measurement performed with use of the simulative antenna 130 for which the voltage standing wave ratio is variable, in advance of the test of the antenna 102. Then, reflected wave power of the antenna 102 is calculated by correcting a power value of the power meter 140 measured by supplying power to the antenna 102 with the correlation coefficient. Therefore, the reflected wave power of the antenna 102 can be measured accurately in the radio transmitter test system 100A as well by performing the processing in steps S100 to S108 described above.

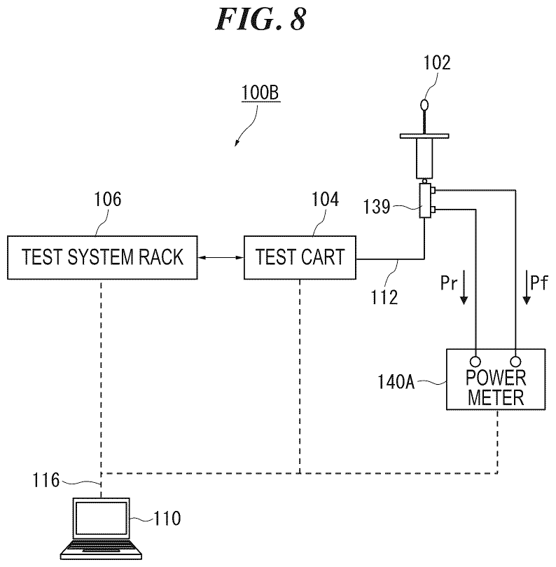

FIG. 8 is a diagram showing a variation of the radio transmitter test system 100 shown in FIG. 5. A radio transmitter test system 100B according to this variation differs from the radio transmitter test system 100 in that a directional coupler 139 and a power meter 140A are added.

The directional coupler 139 is connected immediately below the antenna 102, couples a signal in a low-frequency band to the antenna 102, and outputs traveling wave power Pf and reflected wave power Pr. The power meter 140A is connected downstream of the directional coupler 139 and measures the traveling wave power Pf and the reflected wave power Pr output from the directional coupler 139.

In the radio transmitter test system 100B, when a signal in the low-frequency band (e.g., 3 to 30 MHz) is transmitted to the coaxial cable 112, the directional coupler 139 is connected immediately below the antenna 102 and the power meter 140A is connected downstream of the directional coupler 139, and thus reflected wave power of the antenna 102 can be measured accurately.

Although preferable embodiments of the present invention have been described with reference to the attached drawings, it goes without saying that the present invention is not limited to these examples. It is apparent that a person skilled in the art may conceive various variations and modifications within the scope of the claims, and those variations and modifications should be understood to be naturally encompassed in the technical scope of the present invention.

The present invention is applicable to a radio transmitter test system.

1. A radio transmitter test system comprising:
an antenna connected to a coaxial cable;
a signal generator configured to generate a high-frequency signal;
a power amplifier configured to amplify power of the high-frequency signal;
a simulative antenna for which a voltage standing wave ratio indicating a transmission efficiency of high-frequency power is variable and that is connected to the coaxial cable in place of the antenna;
a directional coupler that is connected between the power amplifier and the simulative antenna, is configured to couple a high-frequency signal whose power has been amplified to the simulative antenna, and to output traveling wave power and reflected wave power between the power amplifier and the simulative antenna;
a power meter that is connected downstream of the directional coupler and is configured to measure the traveling wave power and the reflected wave power output from the directional coupler; and
a control device configured to calculate reflected wave power of the antenna,
wherein the control device includes:
a correlation coefficient calculating unit configured to calculate, for each voltage standing wave ratio of the simulative antenna, a correlation coefficient indicating a correlation between traveling wave power and reflected wave power of the simulative antenna and the traveling wave power and the reflected wave power measured by the power meter; and
a power value calculating unit configured to calculate reflected wave power of the antenna by correcting, with the correlation coefficient, the traveling wave power and the reflected wave power measured by the power meter in a state where the simulative antenna is replaced by the antenna.

2. The radio transmitter test system as claimed in claim 1,
wherein the power value calculating unit is configured to calculate net power, which is effective power, by subtracting the calculated reflected wave power from the traveling wave power of the antenna, and
the control device further includes a control unit configured to control output of the signal generator to supply the net power to the antenna.

3. The radio transmitter test system as claimed in claim 2, further comprising:
an attenuator that is connected between the directional coupler and the simulative antenna via a selector, is configured to attenuate reflected wave power from the simulative antenna, and to output the attenuated reflected wave power to the power amplifier; and
a filter configured to remove high-frequency components of the reflected wave power or to perform impedance matching of a transmission path of high-frequency power, and
the control unit is configured to connect the attenuator or the filter between the directional coupler and the simulative antenna by switching the selector.

4. The radio transmitter test system as claimed in claim 1, further comprising:
another directional coupler that is connected immediately below the antenna, is configured to couple a signal in a low-frequency band to the antenna, and to output traveling wave power and reflected wave power; and
another power meter that is connected downstream of the other directional coupler and is configured to measure the traveling wave power and the reflected wave power output from the other directional coupler.

5. The radio transmitter test system as claimed in claim 2, further comprising:
another directional coupler that is connected immediately below the antenna, is configured to couple a signal in a low-frequency band to the antenna, and to output traveling wave power and reflected wave power; and
another power meter that is connected downstream of the other directional coupler and is configured to measure the traveling wave power and the reflected wave power output from the other directional coupler.

6. The radio transmitter test system as claimed in claim 3, further comprising:
another directional coupler that is connected immediately below the antenna, is configured to couple a signal in a low-frequency band to the antenna, and to output traveling wave power and reflected wave power; and
another power meter that is connected downstream of the other directional coupler and is configured to measure the traveling wave power and the reflected wave power output from the other directional coupler.
